(19) United States
(12) Patent Application Publication
(10) Pub. No.: US 2011/0174618 A1
(43) Pub. Date: Jul. 21, 2011

(54) SAMPLE MEASUREMENT SYSTEM

(75) Inventor: Matthew Robert Bryan, West Yorkshire (GB)

(73) Assignee: MENAI MEDICAL TECHNOLOGIES LIMITED, West Midlands (GB)

(21) Appl. No.: 13/121,509

(22) PCT Filed: Sep. 21, 2009
(86) PCT No.: PCT/GB2009/051225

§ 371 Date: Mar. 29, 2011

(30) Foreign Application Priority Data
Sep. 30, 2008 (GB) 0817842.8
Jan. 19, 2009 (GB) 0900794.9

(51) Int. Cl. G01N 27/28

(52) U.S. Cl. 204/434

(57) ABSTRACT

The present invention relates to a sample measurement system. In particular the invention relates to a sample measurement system for measuring certain selected properties of a liquid substrate, such as the glucose levels in a blood sample. More particularly the invention relates to a sample measurement system for performing electrochemical measurements on a sample, the system comprising a sampling plate with a loading port for receiving a liquid substrate; and a measurement device; wherein the sampling plate comprises a sample zone with at least two discrete testing zones, which sample zone is arranged, in use, to separate the liquid substrate into at least two discrete samples, such that each sample occupies a respective testing zone; and the measurement device is operable to communicate with the sampling plate to measure one or more selected properties of any of the at least two samples.

### FIELD OF THE INVENTION

The present invention relates to a sample measurement system. In particular the invention relates to a sample measurement system for measuring certain selected properties of a liquid substrate, such as the glucose levels in a blood sample. The invention also relates to a sampling plate, a measurement device, an adaptor allowing the sampling plate to communicate with the measurement device, a data carrier containing software to operate the measurement device, a method of manufacturing a sampling plate, a continuous sheet having a plurality of sampling plates, a method of manufacturing a continuous sheet, and an apparatus for manufacturing a continuous sheet.

### DESCRIPTION OF THE BACKGROUND ART

There is a widespread need for sample measurement systems such as those enabling a diabetes patient to know their blood sugar levels—i.e. the concentration of glucose in their blood.

At present, numerous systems exist having a measurement device which receives and reads a sampling plate spotted with a blood sample from a diabetes patient. The sampling plate is typically rectangular and is end-loaded with the blood sample. The blood sample, once loaded, is drawn into a sample zone having a number of testing zones. The sample is sequentially drawn past a first testing zone, following by a second, and then a third until all testing zones have received the sample.

Each testing zone has its own particular contents. For example, the first testing zone has glucose oxidase, the second a mixture of glucose oxidase and a predetermined amount of glucose. The third testing zone is blank. As the blood sample is drawn over all three testing zones, chemical reactions occur with the contents of each testing zone, resulting in discrete electrolytes. Each testing zone bridges a corresponding pair of electrodes. A potential difference is established across each testing zone, via the electrodes, when the sampling plate is inserted into an operating measurement device. Electric current readings for each testing zone then provide measurements necessary to assess the blood sugar (glucose) levels. For instance, the first testing zone gives the primary measurement, whereas the second testing zone provides a degree of calibration since a known quantity of glucose was already present therein. The third zone gives a final check by accounting for the non-glucose contribution to the measurements in the first and second testing zones.

A good example of the system described above is disclosed in WO 2008/029110. The sampling plates of such systems are formed by screen printing techniques.

A problem with such a system is that the sampling plate is end-loaded, with a loading port at one end. Therefore, the loading port is small, and often difficult to use, particularly for the elderly or infirm. Sampling plates are also necessarily thicker to accommodate this arrangement.

Another problem with the system is that there is a high degree of batch to batch variation with the manufacture of the sampling plates, which creates the problem of numerous “performance bands”. Each batch of plates is thus sold bearing a performance band number, which the patient must input into the measurement device before measurements are taken. Incorrect input of the sampling plate performance band number into the measurement device leads to inaccurate measurements. This can happen if a patient forgets to input the correct performance band number when taking a first sampling plate from a new pack of sampling plates, or the patient does not understand the importance of the performance band number. Severely inaccurate results can lead to the need for healthcare intervention.

Another problem is that the measurements are generally inaccurate even where the performance band is entered correctly, and the measurements are properly calibrated. This is due in part to inherent inaccuracy in the manufacturing process of the sampling plates, particularly in respect of the electrodes, and their corresponding testing zones. Inaccuracies also arise due to the sampling technique, which exposes a sample destined for the third testing zone to conditions in the other two testing zones, as it travels along a fluid path. Furthermore, the entire blood sample when drawn over the three testing zones remains as a single continuous sample rather than three discrete samples, since the three samples are linked by blood remaining in the fluid path. This can cause interference between testing zones, which is a particular problem where electrochemical and optical (reflectance and absorbance) measurements are involved. Further accuracy problems arise owing to the inaccurate and inconsistent dosing of the contents of each testing zone. For instance, enzymes are generally deposited on to a testing zone as an ink in a paste-like form. Such pastes are difficult to lay down with any degree of volumetric or positional accuracy.

Another problem is that it is difficult to facilitate uniform division of the blood sample between or to each testing zone, which again gives rise to inaccuracies in the ultimate measurements.

Another problem is that the measurements are displayed by the measurement device in such a way that some patients do not know what the measurements mean or how to interpret the information. Furthermore, such sample measurement systems only allow the measurement of a single property, such as glucose content.

Another problem is that the manufacturing process for the sampling plates is inefficient, with low useable throughput and high product reject rates.

It is an object of the present invention to provide an improved sample measurement system and method of manufacture thereof.

### SUMMARY OF THE INVENTION

In accordance with a first aspect of the present invention there is provided a sample measurement system for performing electrochemical measurements on a sample, the system comprising:

a sampling plate with a loading port for receiving a liquid substrate; and

a measurement device;

wherein the sampling plate comprises a sample zone with at least two discrete testing zones, which sample zone is arranged, in use, to separate the liquid substrate into at least two discrete samples, such that each sample occupies a respective testing zone; and the measurement device is operable to communicate with the sampling plate to measure one or more selected properties of any of the at least two samples.

The measurement device is preferably purpose-built for direct compatibility with the sampling plate. However, the measurement device may be an existing measurement device purpose-built for use with a different sampling plate, but may be rendered to be compatible with the sampling plate of the present invention.

Herein, “to separate the liquid substrate into at least two discrete samples” means to actively separate the liquid substance into and maintain separation of discrete samples.

The invention has the advantage that separation of the liquid substrate into discrete samples is automatic. Furthermore, the separation forms “discrete” samples, i.e. samples which are fully separated from each other. In particular, they are not linked together by a portion of the liquid substrate which may, for instance, otherwise remain on a fluid path between the at least two discrete samples. Discrete samples, rather than samples which overlap, allows for greater accuracy in measurements. The invention also has the advantage that each of the at least two discrete samples is exposed to only one testing zone, thereby avoiding contamination or interference by another testing zone, which may otherwise lead to inaccurate measurements.

The invention allows multiple measurements to be taken in respect of a plurality of discrete samples. For example, one sample may be used to determine one selected property (e.g. physiological condition); another sample may be used to determine another selected property. The measurements may pertain to the same property or different properties, thus allowing for detailed analysis of a liquid substance, such as a patient's blood, using a single sampling plate.

Preferably the system in accordance with the present invention is operable to take an electrochemical measurement in respect of each sample. The system may have three or more testing zones, preferably from three to five testing zones, most preferably four testing zones. The presence of multiple testing zones and samples allows for determination and/or quantification of different metabolites, assessment of different physiological conditions, averaging of measurement results, and validation of measurement results.

The liquid substrate may be blood, for instance, from a diabetic patient. In this case, blood glucose levels may be measured.

It will be understood that the present invention does not exclude multiple loading ports and multiple sampling of different liquid substances. However, preferably a single liquid substance is received by the sampling plate having only one loading port.

The sampling plate may be a strip, such as a flexible strip, or a rigid plate. Preferably the sampling plate is a substantially rigid plate.

The sample zone preferably comprises a hydrophobic zone or boundary (hereinafter hydrophobic boundary) which, in use, lies between the at least two testing zones. A preferred hydrophobic material is flexographic ink, preferably doped with at least one component which increases hydrophobicity, e.g. a detergent. This is advantageous as the hydrophobic boundary separates samples, and/or assists in the separation of the liquid substance into discrete samples.

Each of the at least two testing zones preferably comprises a hydrophilic portion, which is arranged to receive one of the at least two discrete samples. A preferred hydrophilic material is flexographic ink, preferably doped with at least one component which increases hydrophilicity. Surface tension tends to keep each sample in its own testing zone.

Each testing zone preferably comprises a well, where each well is arranged to receive one of the at least two discrete samples. The well may be circular or non-circular (that is at the mouth), and possibly substantially square shaped (i.e. at the mouth). Preferably the well has sides where the sides are substantially sloped. Preferably the sides connect to a base of the well and to a top sheet (in which the well is formed) in a smooth or continuous manner, without any discontinuities. The well may have a surface area of between 2.5 and 4 mm and a depth of 200-300 μm. Each well may comprise the abovementioned hydrophilic portion. A well helps to keep the samples discrete, and also provides a three dimensional target for dosing inks thereinto (see below). This improves the manufacturing process.

The wells are preferably rounded, and preferably circular (that is at the mouth). Preferably the wells are free of corners, preferably free of sharp corners. Preferably the wells comprise a continuous surface, preferably a curved surface. Most preferably the wells are dimples, preferably hemispherical dimples. The hemispherical wells may have a depth between 100 μm and 200 μm.

Preferably the wells contain a pair of spaced electrodes and the electrical bridge between the electrodes is made when a sample enters the wells.

Preferably all of the testing zones are, in use, employed for providing measurements of a sample contained therein. However, one or more of the at least two testing zones may serve an alternative purpose, such as to collect excess liquid substrate to avoid the other testing zones from becoming overfilled.

The sample zone may therefore help separate the liquid substance into discrete samples by virtue of its shape. This may include paths. This may also include troughs, recesses, etc., herein broadly referred to as wells. The sample zone may also help separate the liquid substance by virtue of chemical means. For instance, the sample zone may comprise certain hydrophobic region(s) and/or hydrophobic region(s). Preferably the sample zone helps to separate the liquid substance into discrete samples by virtue of both its shape and the chemical means.

The sampling plate may comprise a spreading means for assisting distribution of the samples to their respective testing zones. In some embodiments, the spreading means may comprise a mesh over the sample zone. Such a mesh may permit the liquid substance to pass therethrough into the at least two testing zones. The mesh helps to spread the liquid substance uniformly over the sampling zone as a whole, and particularly helps spread the liquid substance uniformly over the two or more testing zones.

The mesh may comprise a mixture of mesh hydrophobic and mesh hydrophilic materials. The mesh is preferably cross-hatched. The mesh may comprise parallel strands of hydrophobic material and at least partially orthogonal but parallel strands of hydrophilic material. Alternatively, parallel strands may be alternately hydrophobic and hydrophilic. Provision of hydrophilic material in the mesh helps to spread the liquid substrate. Provision of hydrophobic material in the mesh helps repel the liquid substrate into the testing zones. The mesh may therefore have a top face coated with hydrophilic material, and a bottom face coated with hydrophobic material.

The loading port is preferably arranged on a top face of the sampling plate. Such a top-fill arrangement is preferable to an end-fill, where the loading port is on an edge of the sampling plate. This is because the top-fill arrangement is more accessible for loading a liquid substance, especially for those with reduced dexterity such as the elderly or infirm. Furthermore, sampling plates may be thinner in profile where they are arranged for top-filling. Preferably the loading port is arranged directly above or over the sample zone. This means that the liquid substance once loaded at the loading port, is delivered to the sample zone, possibly assisted by gravity. This is preferable, for instance, over delivery along a fluid path by pure capillary action, which relies on a continuous feed of the liquid substance until the sample zone is suitably supplied with liquid substance. Such pure capillary action delivery requires a greater amount of the liquid substance, e.g. blood, given that some of the liquid substance always remains along the fluid path between the loading port and the sample zone. Such an arrangement also allows gravity to assist or cause splitting and/or delivery of the liquid substance into the at least two testing zones. This helps to ensure that each sample forms within its respective testing zone as a fully discrete sample, rather than being linked to other samples by liquid substance remaining along a fluid path.

Therefore, a top-fill sampling plate, which also has a hydrophobic boundary, allows splitting of a single liquid substance into at least two discrete samples using both physical and chemical means.

Where a mesh is present, the mesh is preferably disposed between the loading port and the sample zone.

The loading port is preferably circular. Preferably the loading port has an area of between 5 and 10 mm². Preferably the loading port comprises an opening in a covering tape.

At least one of the at least two testing zones preferably comprises a laid-down material, which in the medical testing field is conventionally called an “ink” (this term is used hereinafter). The ink may have a pigment, but not necessarily. Preferably the ink comprises a test material, so as to be an “active” ink. Preferably the test material is selected to be chemically reactive with at least one component of the liquid substrate. This reactivity may provide the basis for measurements of a selected property of the liquid substance. The test material is preferably bound to the testing zone, so as not to flow during normal handling of the sampling plate. The test material is preferably dried on to the testing zone, and may be a dried coating, gel or paste. Preferably it is formed from a liquid precursor, preferably a solution of the test material. The test material within the ink is preferably selected to be chemically reactive with glucose. However, the test material may also be selected to be reactive with another component of the liquid substance, such as ketones. The test material preferably comprises an enzyme, preferably either glucose oxidase or glucose dehydrogenase.

Preferably more than one of the at least two testing zones comprises an ink. Each ink may be different or comprise a different test material. Each different ink may react with the same component, so as to provide measurements which are self-calibrating. Alternatively each different ink may react with a different component of the liquid substance, enabling measurement of a plurality of selected properties. Measurement of a plurality of selected properties allows assessment and/or monitoring of a plurality of different illnesses, conditions, and/or medical states (analyte levels/concentration). It also allows assessment or monitoring of such as recreational drug use, or alcohol abuse. In particular it allows assessment of the use of a plurality of recreational drugs simultaneously.

Preferably at least one testing zone comprises a “mediator” ink. The mediator ink is conductive when in solution or mixed with a liquid substance such as blood. This increases the sensitivity of the measurements. The same at least one testing zone preferably further comprises either an active ink or a passive ink. The active ink comprises a test material, whereas the passive ink is the same as the active ink but without the test material. The mediator ink and active or passive ink may be substantially mixed with each other, rather than being layered. This can be achieved by pre-mixing the inks before laying them down in the at least one testing zone.

The sampling plate preferably comprises at least one pair of electrodes connectable to electrical terminals within the measurement device. A pair of electrodes generally consists of an anode/cathode pair. The at least one pair of electrodes is preferably bridged by the liquid substrate in one of the at least two testing zones. In use, that testing zone preferable contains an electrolyte, where the electrolyte is preferably one of the at least two samples, and is more preferably the reaction product of one of the at least two samples with an ink. The measurement device suitably communicates with the sampling plate by applying a potential difference across the at least one pair of electrodes. Such communication preferably provides measurements in respect of the electrolyte to determine certain one or more selected properties of the liquid substance. Such an electrochemical measurement technique is typically more accurate than other sample measurement techniques available in the field, such as optical measurements. Preferably, after loading the liquid sample, the system requires a period of time, preferably from 3 to 15 seconds, before the result is made available.

A pair of electrodes per testing zone does not exclude an embodiment where all or some testing zones have a single common electrode, whether a cathode or an anode. Such a common electrode has a plurality of termini (electrolyte contacts) adjacent to or in each testing zone. In this case each testing zone associated with the common electrode preferably has its own individual opposite electrode, whether an anode or cathode. In fact, a single common electrode arrangement is preferred owing to ease of manufacture of both the sampling plate and the corresponding measurement device.

The electrodes are preferably printed, most preferably flexographically printed electrodes. The printed electrodes preferably comprise an ink. Said ink preferably comprises conductive particulates such as carbon and/or graphite. The ink may be printed to a specific design.

Preferably a space between the electrodes comprises insulating material, preferably printed insulation material, most preferably flexographically printed insulation material. This helps prevent signal interference between electrodes. The insulation material preferably comprises an ink that is free of conductive particulates or conductive ingredients, and is preferably printed to a specific design that electrically isolates the conductive electrodes from each other.

The electrolyte is preferably producible by a chemical reaction between at least one component of the liquid substrate and the ink. Selected properties may be measurable from an electric current measurement. A constant potential difference, preferably between 100 and 1000 millivolts (mV), through the at least one pair of electrodes and across a corresponding testing zone may give rise to an electric current, which current is dependent on the selected property, e.g. glucose concentration. In some embodiments it is believed that the anode and cathode actually cause a chemical reaction. In other embodiments the anode and cathode are believed not to cause a chemical reaction.

The sampling plate or precursor therefor preferably comprises a first flexographic print layer. The flexographic print layer may be either a complete layer or a partial layer. Preferably the sampling plate comprises a second flexographic print layer, preferably printed relative to the first. Preferably the sampling plate comprises subsequent flexographic print layers, also printed relative to the first. The position of second and subsequent print layers are preferably all relative to registration points on a precursor sheet. More preferably the sampling plate comprises a plurality of flexographic print layers printed at a single discrete processing station.

Preferably the first flexographic print layer or plurality of flexographic print layers are on a platform. The platform may be polymeric, preferably a polyvinylchloride (PVC) precursor sheet or plate, but is preferably comprised of paper-based material, such as card. The platform is preferably coated with a lacquer. The platform preferably comprises on at least one side at least one flexographic print layer. The first flexographic print layer may be a hydrophilic layer, preferably covering substantially the entire surface of the platform. Such use of paper-based material is an environmentally friendly alternative to a PVC platform. It also reduces dependency on oil-based materials, which are more exposed to price fluctuations.

Flexographic print layers are highly advantageous in relation to sampling plates of the present invention. Flexographic manufacturing allows for high throughput and great accuracy of printing, particularly in relation to three dimensional surface structure. This in turn provides for more accurate measurements of samples. Flexographic printing is furthermore, a highly consistent manufacturing technique giving little batch to batch or intra-batch variation. This goes some way to alleviating the need for “performance bands” used with traditional sampling plates. A sampling plate can be categorized as having a particular performance band based on its manufacturing batch information. A performance band is an indication of the performance level of a particular sampling plate. Traditionally, each sampling plate is sold with packaging information that includes a performance band number which is to be inputted into the measurement device before measurements are made. This calibrates a given sampling plate based on its performance band (see below) to allow meaningful measurements to be made regardless of the sampling plate used. Flexographic print layers are, however, so accurate that few (preferably a maximum of 3) or no performance bands are required, thus simplifying the manufacture and operation of the measurement device.

The sampling plate preferably comprises a flexographically printed electrode (or printed circuit board). Furthermore, the sampling plate preferably comprises a flexographically printed sample zone, preferably including any hydrophobic boundaries and/or hydrophilic portions/wells. This again provides accurately manufactured sampling plates which give more accurate sampling and consequently more accurate measurements.

The ink is preferably a high-precision dosed ink. This again provides for more accurate measurements, and reduces batch to batch or intra-batch variation. High-precision dosing preferably involves dosing an ink, such as an enzyme, as a mobile solution, preferably a solution with a density of about 1 g/mL, but preferably at most 2 g/mL. Preferably the solution comprises ethanol as a solvent. This avoids the dosing problems associated with using pastes of the ink. Preferably the high-precision dosed ink has a dose volume between 100 mL and 150 mL, and is dosed with a tolerance of +/−5 mL or better. The dose volume is the volume of the dosed ink solution. Drying will remove most of the volume after dosing.

The sampling plate may comprise an information tag, readable by an information tag reader associated with the measurement device. The information tag may include, but is not limited to, product authentication information. This may prevent harmful circulation/use of counterfeit sampling plates. The information tag preferably comprises a performance indicator, arranged to communicate with the measurement device. The measurement device therefore preferably comprises a performance indicator reader (preferably comprised of the information tag reader) to read the performance indicator. Preferably the performance indicator is for automatic performance band calibration. This avoids the need for a user to input a performance band into the measurement device before taking measurements. The performance indicator is preferably a performance band transmitter arranged to communicate with a performance band receiver comprised of the measurement device. Preferably the transmitter is a radio frequency transmitter such as an RFID tag (radio-frequency identification tag).

The information tag may contain batch information, particularly batch information pertaining to the production of the specific sampling plate. Such batch information may allow for total traceability of the sampling plate by reference to batch records. Such batch records may include information regarding the sampling plate's constituent parts, and materials, along with process control and operator efficiency during the sampling plate's production. Therefore the batch information may be a simple master batch number which refers to relevant batch records. Therefore, a faulty sampling plate may be interrogated to provide a reference to all quality records associated with its production. In this case, the information tag may be read by the information tag reader of the measurement device, as described above. However, the information tag may also be read by an information tag reader linked to a computer, which may include the measurement device being linked to a computer.

The measurement device preferably comprises a memory, such as RAM, for information storage. The memory preferably stores test results. Test results may include: measurements, units of measurements, time and date. The memory may store further information inputted by a patient, including whether a test was performed before or after a meal, before or after exercise, medication type, and quantities. The information stored within the memory is preferably accessible to allow a historical analysis of the test results. Preferably the information stored in the memory can be transferred to a computer, and a database may be constructed therefrom.

Preferably the memory comprises visible memory and invisible memory, where the visible memory is readily accessible as described above; for example to a patient, or relevant medical personnel. The invisible memory is preferably less accessible, or arranged to be accessible to technicians or skilled personnel. The invisible memory may be arranged in use to store the batch information of each sampling plate used in each test. Each piece of batch information may be linked to a respective test result. This allows for interrogation of the measurement device to establish if, when, and where an error has occurred, and how such an error may have affected the corresponding test result. The batch information may then be used to establish whether there was a problem with a batch of sampling plates, or whether the fault resides with the measurement device itself. This allows for rapid diagnosis of faults and quick resolution. This is especially true where batch records are electronically accessible.

The invisible memory may also store information regarding errors generated during tests. This may include any warning messages displayed to the user. System calibration problems may also be stored.

It is a preferred feature to split the memory into visible and invisible memory, but all information from the information tag may be stored in the memory, whether or not it is so split.

The measurement device is preferably arranged to receive the sampling plate without adaptation, that is the sampling plate is preferably insertable directly into the measurement device rather than via an adaptor. The measurement device may be arranged to receive the sampling plate without an adaptor. The measurement device preferably operates pursuant of software. The software is preferably arranged to be compatible with the sampling plate without adaptation or modification. The software preferably precludes the use of other sampling plates outside the scope of the present invention with the measurement device, without an authentication signal. Such an authentication signal may be provided to the measurement device by an adaptor. Such an authentication signal may be received and/or validated by the information tag reader.

The sample measurement system may further comprise an adaptor to allow the measurement device to communicate with the sampling plate. The adaptor may allow a sampling plate of the present invention to be adapted for use with a traditional measurement device. In this case such a traditional measurement device may serve only as a display device to display measurement results, which measurement results are generated by the adaptor itself. In such a case, the adaptor itself may comprise an information tag reader, preferably comprising a performance indicator reader. The performance indicator reader may receive performance band information from the performance indicator of the sampling plate, and use such information to calibrate measurement results before sending the results to be displayed on the traditional measurement device. Compatibility with old measurement devices may be important for a smooth transition to using the technology of the present invention, as the measurement devices are more expensive than the sampling plates. Furthermore, patients often prefer to keep a measurement device with which they are already familiar.

Alternatively, the adaptor may also allow traditional sampling plates to be used with the measurement device of the present invention. In this case, the adaptor may itself comprise an information tag which communicates information about the traditional sampling plate to the information tag reader.

The measurement device preferably comprises a data carrier, which data carrier comprises software arranged to control the measurement device. The measurement device may be configured to display a variety of information and/or measurements pertaining too the liquid substance. Furthermore, the configuration may be customised. The measurement device may comprise a computer. The sampling plate may be arranged or adapted by the adaptor to be connectable with the computer, for example, via a USB port.

In accordance with a second aspect of the present invention there is provided a sampling plate as described in the first aspect.

In accordance with a third aspect of the present invention there is provided a measurement device as described in the first aspect. The measurement device is preferably arranged to receive the sampling plate of either the first or second aspect without adaptation, for instance with an adaptor. The measurement device may be handheld.

In accordance with a fourth aspect of the present invention there is provided an adaptor as described in the first aspect. The adaptor may be connectable between the measurement device and any other sampling plate, or the sampling plate and any measurement device. The adaptor may comprise electrical connectors (contacts) to connect the at least one pair of electrodes of the sampling plate to a power source or terminals within the measurement device.

Where the adaptor is connectable between the sampling plate of the present invention and any measurement device, the adaptor may comprise a signal manipulator. The signal manipulator is preferably arranged in use to manipulate one or more sampling plate output signals to provide one or more adaptor output signals, which adaptor output signals are compatible with the measurement device and usable to measure one or more selected properties of any of the at least two samples of the sampling plate. Preferably none of the one or more sampling plate output signals are compatible with the measurement device. Preferably the number of adaptor output signals is less than the number of sampling plate output signals. Moreover, the signal manipulator may also manipulate one or more signals in the opposite direction, i.e. between the measurement device and the sampling plate.

The adaptor may comprise a processor. Preferably the processor is a computer processor, preferably comprising a microchip. The processor may be comprised of the signal manipulator. The processor preferably manipulates the signals before they are fed into the measurement device.

The adaptor of the present invention allows a user to keep and continue using an old measurement device whilst still benefiting from at least some of the advantages of the sampling plate of the present invention.

In accordance with a fifth aspect of the present invention there is provided an adaptor for connecting any sampling plate (not necessarily as defined in the first aspect) to any measurement device (not necessarily as defined in the first aspect). The adaptor may comprise a processor for managing two-way communication between the sampling plate and measurement device, which may otherwise be incompatible.

In accordance with a sixth aspect of the present invention there is provided a data carrier as described the first aspect.

In accordance with a seventh aspect of the present invention there is provided a method of manufacturing a sampling plate (preferably but not necessarily as defined in the first aspect) for receiving a liquid substrate, comprising:
flexographically printing at least one layer upon the sampling plate.

In accordance with an eighth aspect of the present invention there is provided a method of manufacturing the sampling plate as defined in the first aspect for receiving a liquid substrate, comprising:
flexographically printing at least one layer upon the sampling plate.

The at least one layer may be a partial layer, or alternatively a substantially complete layer. The method of either the seventh or eighth aspect preferably comprises flexographically printing one or more of: a hydrophilic layer, at least one pair of electrodes, insulation for the at least one pair of electrodes, a hydrophobic layer, decorative artwork. The sampling plate is preferably arranged to receive a blood sample.

The method preferably further comprises flexographically printing a plurality of layers upon the sampling plate. The method preferably comprises flexographically printing a plurality of layers upon the sampling plate at a single discrete processing station. This enables high throughput whilst retaining manufacturing precision.

The method preferably comprises producing at least two three dimensional wells in the sampling plate arranged in use to retain a sample of the liquid substrate. The at least two wells are preferably produced immediately prior to or immediately after flexographically printing any layers on the sampling plate. Preferably the at least two wells are produced in the same manufacturing process step as the flexographic printing. Preferably the at least two wells are produced after flexographically printing the at least one pair of electrodes. Each well preferably corresponds with a discrete testing zone.

The method preferably comprises flexographically printing at least one pair of electrodes upon the sampling plate. The method may comprise flexographically printing one or more additional layers of electrodes upon the first layer of electrodes—this may increase conductivity. The method preferably further comprises flexographically printing an insulation layer over a substantial part of the at least one pair of electrodes. Preferably the insulation layer extends between electrodes—this reduces signal interference. Preferably printing of the insulation layer leaves a terminal contact for each electrode to be connectable to terminals of an electrical power source, and also leaves an electrolyte contact which ensures the electrodes are connectable, in use, to an electrolyte upon the sampling plate.

The method preferably comprises flexographically printing a sample zone with at least two discrete testing zones arranged, in use, to separate the liquid substrate into at least two discrete samples, such that each of the at least two discrete samples occupies one of the at least two testing zones. The method preferably further comprises flexographically printing a hydrophobic boundary upon the sample zone, which hydrophobic boundary is arranged, in use, to keep the at least two discrete samples completely separate, in corresponding discrete testing zones. The flexographic printing of the hydrophobic boundary is preferably around each of the testing zones, and also preferably around each of the at least two three-dimensional wells.

The method preferably comprises dosing an ink selected to be chemically reactive with at least one component of the liquid substrate to at least one of the at least two testing zones. Preferably the dosing involves dosing the ink as a solution comprising a solvent. Preferably the viscosity of the solution is about 0.8 to 1.2 mPa·s. Preferably the solvent comprises ethanol.

The method may comprise attaching a mesh to the sampling plate, preferably to cover the sample zone, or all of the at least two testing zones.

The method preferably comprises attaching a covering tape to the sampling plate. Preferably there is an aperture in the covering tape corresponding to the position of a loading port for loading the sample.

The method may comprise attaching an information tag, which preferably comprises a performance indicator, to the sampling plate. Preferably the performance indicator is an RFID tag (a radio frequency identification tag). The performance indicator preferably contains batch specific information, preferably information about the performance band of any particular sampling plate. The method may therefore further comprise testing a sampling plate from a batch of sampling plates to establish the performance band of a particular batch or part of a particular batch.

The method may comprise cutting the sampling plate from a continuous sheet comprising a plurality of sampling plates. Preferably cutting is guided by at least one registration point formed upon either a sampling plate or elsewhere on the continuous sheet. Preferably there are a series of registration points. Preferably the at least one registration point is flexographically printed.

In accordance with a ninth aspect of the present invention there is provided a method of manufacturing a continuous sheet comprising a plurality of sampling plates, the method comprising:

producing a first sampling plate, by the method of the seventh or eighth aspect upon a continuous sheet;

producing a second sampling plate adjacent to the first sampling plate, upon the continuous sheet.

The method preferably further comprises forming a first and second registration point on the continuous sheet, each corresponding with the first and second sampling plates. The registration points preferably allow an apparatus for producing sampling plates to reference the position of each sampling plate. Preferably the method comprises forming a series of registration points on the continuous sheet.

The method preferably comprises making perforations in the continuous sheet around the first and second sampling plates. The perforations are arranged to assist cutting or separating sampling plates.

The method may further comprise cutting the continuous sheet. Cutting preferably separates the first sampling plate from the second sampling plate. Cutting may leave a smaller continuous sheet with a plurality of sampling plates, such as a card of sampling plates.

According to a tenth aspect of the present invention there is provided a continuous sheet comprising a plurality of sampling plates, as produced by the method of the ninth aspect. The continuous sheet may be a card or sheet of sampling plates cut from a larger continuous sheet.

According to an eleventh aspect of the present invention there is provided an apparatus for carrying out the method of the ninth aspect and for producing the continuous sheet of the tenth aspect.

According to a twelfth aspect of the present invention there is provided a method of testing a medical condition comprising:
a) loading a liquid substance from the body to a sampling plate of the first or second aspect;
b) operating a measurement device, of the first or third aspects, to communicate with the sampling plate to measure one or more selected properties of the liquid substance.

The method preferably comprises testing diabetes. The method may comprise testing for the presence of one or more recreation drugs, and may include tests for alcohol.

The method may comprise testing cardiac conditions, such as elevated adrenalin levels. Potentially any condition which causes a change in concentration of a component in the blood (indicative chemistry) may be tested for.

According to a thirteenth aspect of the present invention there is provided a diagnostic kit for testing a medical condition, comprising the sampling plate and the measurement device.

Preferred features of one aspect of the present invention are also preferred features of any other aspect.

### BRIEF DESCRIPTION OF THE DRAWINGS

For a better understanding, the present invention is now described with reference to the following diagrammatic drawings, in which:

FIG. 1 is a projection view of a sample measurement system according to an exemplary embodiment;

FIG. 2 is a top projection view of a sampling plate according to the exemplary embodiment of FIG. 1;

FIG. 3 is a top projection of internal components of the sampling plate of FIG. 2;

FIG. 4 is a top view of a sample zone of the sampling plate of FIG. 2;

FIG. 5a is a projection view of a sample measurement system according to another exemplary embodiment;

FIG. 5b is a projection view of a sample measurement system according to another exemplary embodiment;

FIG. 5c is a projection view of a sample measurement system according to another exemplary embodiment;

FIG. 5d is a circuit diagram showing the internal components of the adaptor of FIG. 5b;

FIG. 5e is a circuit diagram showing the internal components of an alternative adaptor of FIG. 5b;

FIG. 6 is a flow diagram overview of the method of producing a sampling plate;

FIG. 7 is an expanded flow diagram of Step 1 of FIG. 6;

FIG. 8 is an expanded flow diagram of Step 2 of FIG. 6;

FIG. 9 is an expanded flow diagram of Step 3 of FIG. 6;

FIG. 10 is a top view of a card produced from Step 3 of FIG. 6; and

FIG. 11 is an expanded flow diagram of Step 4 of FIG. 6.

### DETAILED DESCRIPTION OF EXEMPLARY EMBODIMENTS

The exemplary embodiments will now be discussed in detail in relation to an improved sample measurement system, and method of manufacture thereof. In particular the following embodiment relates to a system with a sampling plate for sampling a liquid substance, particularly blood, and a measurement device for measuring selected properties of the blood, particularly glucose levels. This system is especially applicable to a diabetes patient monitoring blood sugar levels.

FIG. 1 is a projection view of a sample measurement system according to an exemplary embodiment, and shows a sampling plate 100 inserted into a measurement device 200. The sampling plate 100 has a loading port 110 for receiving a blood sample on a top face of the sampling plate 100. Directly below the loading port 110 is a sample zone 120 having four discrete testing zones 122, which in this example are three dimensional wells 122. Each well 122 is 250 μm deep, is 1.5 mm wide, and 1.5 mm long. In this example, each of the four wells 122 contains an ink 124. Three of the wells contain an active ink along with a mediator ink. The mediator helps conductivity, and the active ink contains a test material selected for its reactivity with glucose in the blood. In this example, the active ink contains glucose dehydrogenase. The remaining well contains a passive ink along with the mediator ink, where the passive ink is identical to the active ink but without the glucose dehydrogenase. In another embodiment at least one of the wells is spiked with a known quantity of glucose. This assists calibration when conducting measurements. The measurement device 200 has a plate port 210 into which the sampling plate 100 is inserted, and a screen 220 for displaying results, measurements, and/or other desirable data.

In an alternative embodiment the wells 122 are hemispherical. The curved nature of the hemispherical wells is advantageous in that there is a lower risk of the dried inks (in this case flexographically printed conductive inks) cracking than where there are sharp corners such as in rectangular or square wells. In this example, the hemispherical wells (or dimples) have a depth of 150 μm.

Furthermore, the sampling plate 100 has a performance indicator 150. The performance indicator 150 contains information about the sampling plate which, in this example, is transmittable to the measurement device 200. The measurement device 200 has a performance indicator reader (not shown) which reads the information from the performance indicator 150. In this example the performance indicator 150 is an RFID tag which transmits calibration data to the performance indicator reader (a radio frequency receiver). The calibration data relates to the quality of the sampling plate (“performance bands”), for which there can be variation from batch-to-batch or intra-batch. The measurement device 200 then automatically corrects measurements based on the calibration data received to ensure that measurements are consistent from plate to plate, regardless of batch/intra-batch variation.

The performance indicator 150 additionally contains product authentication information to prevent against harmful circulation/use of counterfeit sampling plates. The authentication information is in the form of an encrypted code which can be verified and validated by the measurement device 200.

The performance indicator 150 contains batch information pertaining to the specific sampling plate. The batch information includes a master batch number which refers to the relevant batch records for that particular sampling plate. This renders each sampling plate traceable back to its source materials and production.

The measurement device 200 has a random access memory (RAM) for storing both information from the performance indicators 150 and information/results generated during blood tests. The stored performance indicator information is automatically linked to the corresponding blood test information/results for any particular sampling plate/test.

Blood test results include: measurements, units of measurements, time and date, and also additional information inputted by a patient, including whether a test was performed before or after a meal, before or after exercise, medication type, and quantities. Test results stored within the memory are accessible to allow for a historical analysis of the test results. The information stored in the memory is easily transferable to a computer by linking the measurement device 200 to a computer. In this example, the computer is arranged to assemble a database from the test results to allow a patient's care regime to be carefully monitored.

In this example the memory (RAM) is split into visible and invisible memory, where the visible memory is readily accessible as described above. The invisible memory is only accessible to technicians trained in how to interrogate the measurement device 200. The invisible memory stores batch information for each sampling plate used in a test. Each piece of batch information is linked to a respective blood test result. This allows for interrogation of the measurement device to establish if, when and where an error has occurred. If an error has occurred, the batch information can be used to establish whether there was a problem with a batch of sampling plates (by reference to the relevant batch records), or whether the fault resides with the measurement device itself. This allows any faults to be diagnosed and resolved quickly. This is especially true where batch records are electronically accessible.

In this example, the invisible memory also stores information regarding errors generated during tests, including warning messages displayed to the user. System calibration problems are also stored in the invisible memory.

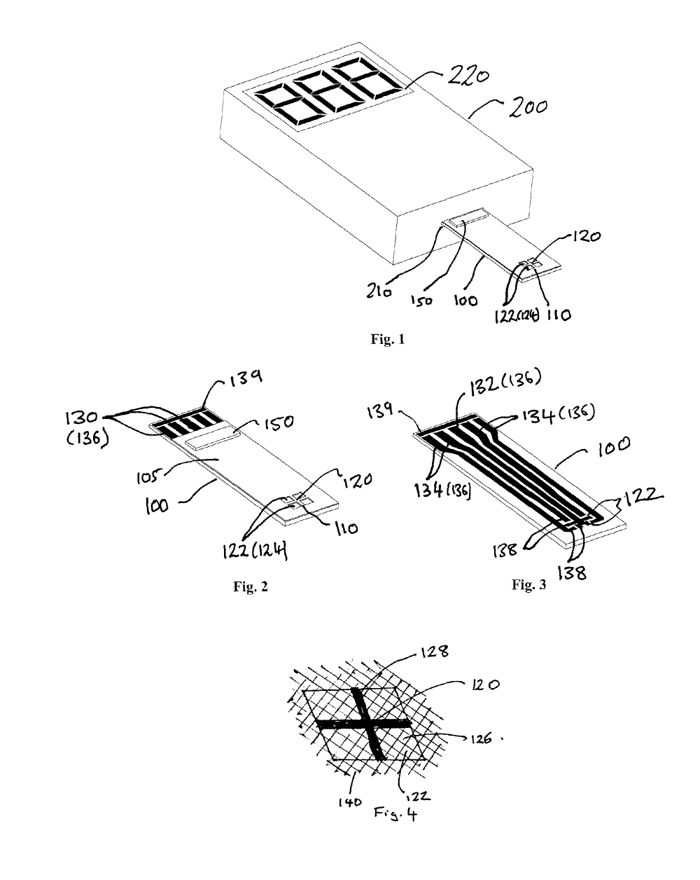

FIG. 2 is a top projection view of the sampling plate 100, and in addition to FIG. 1 shows a covering tape 105, having an aperture 110 corresponding with the loading port 110, and a series of electrodes 130, the ends (terminal contacts 136) of which connect to electrical terminals within the measurement device 200 to allow measurements to be taken.

FIG. 3 is a top projection of internal components of the sampling plate, and shows the electrodes 130 which, in this example, are formed as a printed circuit board. There is a central single common electrode 132 common to all four wells 122. Four individual electrodes 134 join each well. In this example the common electrode 132 is a cathode, and the four individual electrodes 134 are anodes. Each electrode has a terminal contact 136, and an electrolyte contact 138. Each well 122 bridges a gap between each pair of electrodes 130, specifically between a pair of electrolyte contacts 138, where each pair consists of the common electrode 132 and an individual electrode 134. When an electrolyte is present in any of the four wells 122, a current can flow through its corresponding pair of electrodes 132, 134 when the sampling plate 100 is inserted into the measurement device 200 and the measurement device 200 is operated. In this example a four-channel circuit may be produced, enabling four sets of electrochemical measurements on a single sampling plate. The terminals within the measurement device 200 provide a potential difference (voltage) of between 400 and 500 mV. The measured current (microamps) is then proportional to the concentration of glucose within a given blood sample. The sampling plate 100 also comprises a electrical switch bar 139, which acts as a switch to turn on the measurement device 200 when the sampling plate 100 is inserted thereinto.

FIG. 4 is a top view of the sample zone 120 of the sampling plate 100. The sample zone 120 has wells 122 made of hydrophilic material, each well 122 being separated from each other well 122 by a hydrophobic boundary 128. In one embodiment, overlaying the sample zone 120 is a cross-hatched mesh 140. The mesh 140 is made from a mixture of hydrophilic and hydrophobic materials, and in this embodiment has a small clearance from the wells 122 to avoid the mesh 140 dipping into any samples received by the wells 122. The mesh 140 is designed to assist in the uniform distribution of the blood sample. In an alternative embodiment there is no mesh. Alternatively other structures may be incorporated to achieve the effect of distribution/dividing the sample.

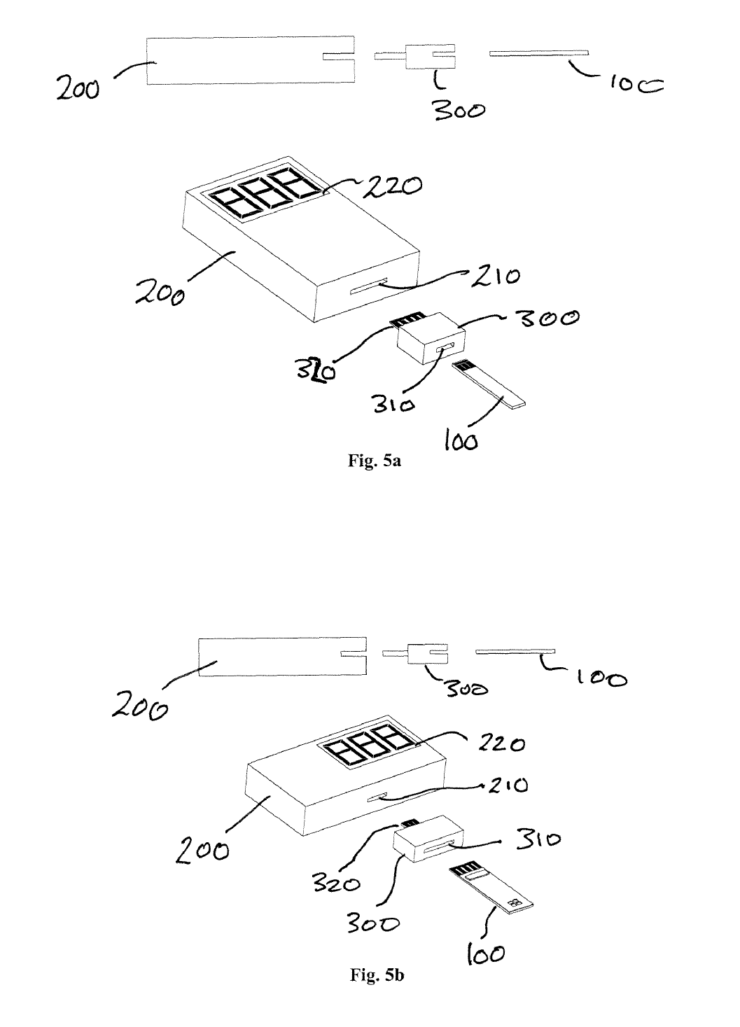

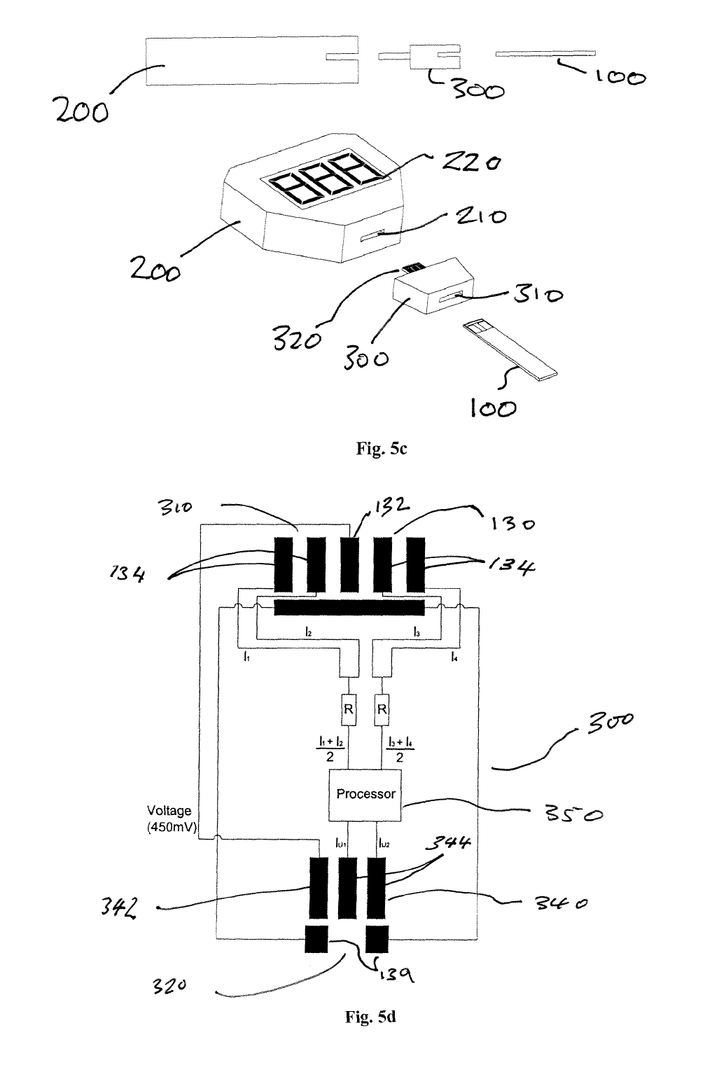

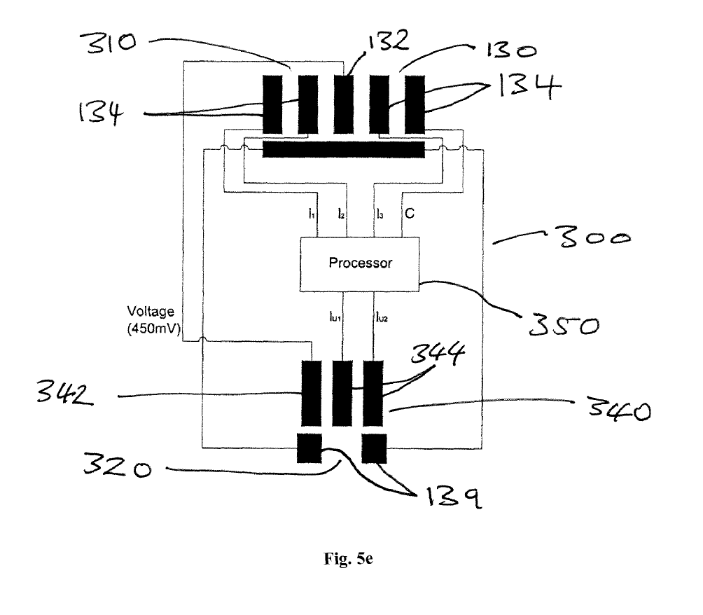

FIGS. 5a, 5b, and 5c are projection views of a sample measurement system according to alternative exemplary embodiments. In each case, a sampling plate 100 is connected to a measurement device 200 via an adaptor 300. In each case, the sampling plate is not directly compatible with the measurement device (i.e. not designed to fit directly into the plate port 210). The adaptor 300 has a plate end 310 (or plate insertion end) designed to receive the sampling plate 100. The plate end 310 has electrical contacts which receive and connect with the terminal contacts 136 of the sampling plate electrodes 130. The adaptor 300 has a device end 320 arranged to simulate a sampling plate which fits directly into the measurement device, and therefore has electrical contacts (pins) arranged to link the electrodes 130 of the sampling plate 100 to corresponding electrical terminals within the measurement device 200. Within the adaptor is a processor which manages the two-way communication between the sampling plate 100 and the measurement device 200. Embodiments of the adaptor 300 enable compatibility between various sampling plates 100 and measurement devices 200. FIG. 5a shows the measurement device 200 of the embodiment of FIG. 1 adapted to receive an otherwise incompatible sampling plate 100. FIG. 5b shows the sampling plate 100 of the embodiment of FIGS. 1 to 4 adapted to fit into an otherwise incompatible measurement device 200. FIG. 5c shows a sampling plate 100 (not of the previous embodiment) adapted to fit into an otherwise incompatible measurement device (not of the previous embodiment).

It will be understood that where the measurement device 200 is a traditional device or other device not arranged or adapted in accordance with the invention, such a device 200 will not have a performance indicator reader, but may still be capable of providing accurate measurements from the sampling plate 100 where the “performance band” is inputted manually into the measurement device.

FIG. 5d shows a circuit diagram of the components within the adaptor 300 of FIG. 5b. The electrodes 130 of the sampling plate 100, as illustrated in FIGS. 1 to 4 interface with the adaptor 300 at contacts at the plate end 310, and are connected by printed circuitry to electrodes 340 at the device end 320. The central single common electrode 132 is directly electrically connected to a primary electrode 342 at the device end 320. In this example, both of these electrodes are cathodes. The four individual electrodes 134 (anodes) connect to two secondary electrodes 344, at the device end 320, via a signal manipulator which, in this example, is a computer processor 350. The processor 350 manipulates four independent signals from the sampling plate 100 to produce two signals that are compatible with the traditional measurement device's hardware and calibration software. Signals I₁ and I₂ become I_{U1} and signals I₃ and I₄ become I_{U2}.

FIG. 5e shows an alternative arrangement whereby the sampling plate 100 employs three of the anodes 134 (I₁, I₂, I₃) for sample measurements, and one of the anodes 134 (C) for correction measurements. In this case, three of the currents (I₁, I₂, I₃) are generated through an enzymatic reaction, as discussed above, but a fourth current (C) represents a background signal, which is used for correction. The processor performs a first calculation to generate three corrected glucose signals from the three signals I₁, I₂, and I₃, and also signal C. In this example, the measurement device 200 needs to receive two input signals to make blood glucose measurements. Therefore the processor then manipulates the three corrected signals to produce two signals, I_{U1} and I_{U2}, which are compatible with the particular measurement device 200.

As shown in FIG. 5b, the adaptor 300 fits into the plate port 210 by virtue of the device end 320. The device end 320 simulates almost entirely the electrical contacts of otherwise directly compatible sampling plates, except the electrical switch bar 139 is divided into two separate terminals, which connect only when a sampling plate 100 is inserted into the plate end 310 of the adaptor 300. This prevents the measurement device 200 switching on when the adaptor 300 is inserted without a sampling plate 100.

The measurement device 200 of either embodiment of FIG. 1 or 5 has a data carrier containing software. The data carrier may also receive and store data, such as measurements. The measurement device 200 operates pursuant to the software. The software has a default setting which takes current (microamps) measurements from three of the four channels. In this example, the measurement device 200 uses multiplexing to measure each of the four channels separately and sequentially. In other examples measurements from all four channels are taken simultaneously. “Multiplexing” is where a cycle of pulse measurements are taken from each channel in turn before repeating the cycle. In this case, multiplexing occurs at approximately 50 Hz. The data is processed and the results are displayed on the screen 220. In this example the results are indicative of blood glucose levels. Results may be displayed as raw data, or as “high”, “low”, etc. Messages relating to the new test result and how it compares to the patient's personal parameters will be displayed. Measurement devices 200 applicable to the present invention are well described in WO 2008/029110, along with their operation.

The measurement device 200 according to the embodiments of both FIGS. 1 and 5 can interface with an ordinary personal computer to allow the raw data to be processed in a customised manner. This furthermore allows unique presentation of the results. The device 200 is simply connectable to a computer as a standard external disc drive.

The sample measurement systems described above are simple to use. The following procedure is employed:
1. The diabetic patient inserts a new test strip 100 into the plate port 210.
2. The measurement device 200 then prepares for receiving measurements and conducts system checks (approximately 3 seconds).
3. The device 200 requests the patient to apply a blood sample to the sampling plate 100.
4. The patient applies a blood sample to the sampling plate 100 via the loading port 110.
5. The device 200 takes measurements for approximately 5 to 10 seconds.
6. The device performs calculations, statistical manipulations, and displays measurement results and accuracy levels.
7. The measurement results and accuracy levels are stored in the device's 200 memory.

In this example the device 200 switches on as soon as the plate 100 is inserted into the port 210, by virtue of the switch bar 139. During step 4, the sampling plate 100 automatically separates the blood into the four discrete wells 122. The optional mesh 140 spreads the blood substantially uniformly across the sample zone such that blood samples drip from the mesh 140 under gravity into their respective wells 122. The hydrophobic boundary 128 also ensures that any blood dripping thereupon is directed towards the hydrophilic wells 122, using both surface tension and gravity.

Where the mesh is absent, the sample zone performs all the separation and spreading work itself.

The device 200 processes the measurements in view of the calibration data from the RFID tag 150, and also internally calibrates and/or performs accuracy level calculations from the measurements taken from each of the wells 122. Internal calibration is effected by the use of statistical algorithms based on the inks and components of the blood which are the subject of measurement. Statistical algorithms are also used to establish the accuracy level of the measurements taken. The screen 220 then displays the result either as raw data, such as blood sugar concentration, or as “high” or “low”, depending on the user's preference. The device 200 also displays the accuracy level. Messages relating to the new test result and how it compares to the patient's personal parameters will be displayed.

Results are calculated on the basis of current decay across a particular well as measured over 5 to 10 seconds. The rate of decay provides an indication of blood glucose levels.

In this example the measurement device 200 also displays, on the screen 220, an accuracy level or an error message if the accuracy level is outside a predefined range. Regulation dictates that blood glucose measurement systems must provide test results with a minimum accuracy level. Thus the predefined range will always comply with regulatory standards. Thus any results with an accuracy outside these limits will give rise to an error message, indicating that the test should be repeated.

In this example, the sampling plates 100 are produced as follows.

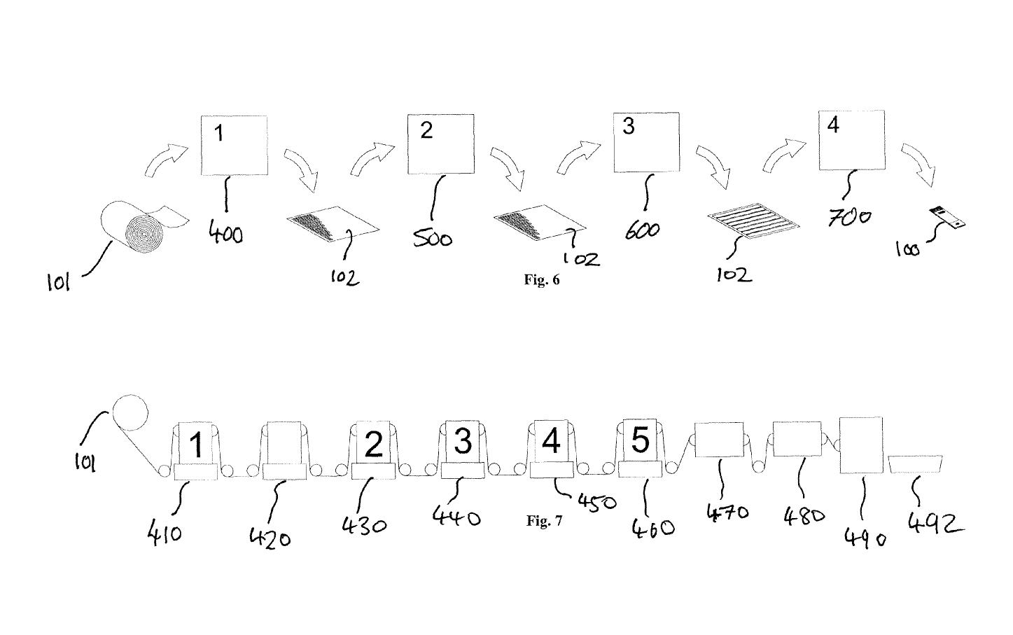

FIG. 6 is a flow diagram overview of a method of producing a sampling plate from a continuous sheet. The diagram shows the method being carried out at four processing stations, including:

Step 1: A flexographic printing station 400;

Step 2: A precision dosing station 500;

Step 3: A card finishing station 600; and

Step 4: A strip cutting and vialing station 700.

A continuous sheet in the form of a continuous roll is fed into the flexographic printing station 400. In this example, the continuous sheet is calendered cardboard. It is calandered to provide the sheet with a greater level of uniformity to reduce variations in the strips ultimately produced. In this example, the continuous sheet is also supplied with a surface that is hydrophilic in nature. Alternatively a hydrophilic coating may be applied at the beginning of the flexographic printing process. The output of step 1 is a smaller continuous sheet, in this example a card having 200 sampling plates (strips), arranged as 8 rows of 25 strips. Inks are then precisely dosed during step 2 at the precision dosing station 500. Step 3 involves finishing the card by applying additional layers at the card finishing station 600. Finally Step 4, at the strip cutting and vialing station 700, involves cutting the card to provide individual strips ready for use and packaging sets of strips in vials.

FIG. 7 is an expanded flow diagram of Step 1 of FIG. 6, and shows the flexographic printing process at the flexographic printing station 400 in more detail. The flexographic printing station 400 comprises a plurality of in-line flexographic print modules and further process modules. A continuous roll 101 is first fed into a first flexographic print module 410 for printing the electrodes 130 and registration points. There is a registration point at regular intervals along the roll 101. The roll then proceeds to a surface deformation module 420, where four three-dimensional wells 122 are formed, in respect of each strip 100 on the roll, using a roller tool set. The roll then proceeds to a second flexographic print module 430, where the insulation layer is printed over the electrodes, so as to leave terminal contacts 136 and electrolyte contacts 138. The insulation layer is composed of ingredients that do not conduct electrical signals (resin and photo-curing agents), and is applied between the electrodes 130 to minimise signal interference which, for instance, can be induced in neighbouring electrodes if uninsulated. At a third flexographic print module 440, the hydrophobic boundary 128 is printed around the wells 122. At a fourth flexographic print module 450, a first decorative artwork colour is flexographically printed in respect of each strip 100 on the roll 101. At a fifth flexographic print module 460, a second decorative artwork colour is printed. Optionally there may be additional flexographic print modules for printing additional artwork. Such flexographic printing allows for high resolution images small enough to be printed on a sampling plate 100. Such images may provide simple information or alternatively enhance product aesthetics, or include branding etc. The roll then proceeds to an edge trimming module 470, where edges of the roll 101 are trimmed based on the positions of the registration points. The roll then enters a perforating module 480, where accurately aligned micro-perforations are applied to the roll along an edge of each row of strips. Finally the roll enters a card cutting module 490 where the roll is cut to produce a number of cards 102, which are deposited in a first card collector 492. Each card contains two hundred strips (8 rows of 25 strips). The roll 101 proceeds through the flexographic printing station 400 on conveyer rollers 402 until it is cut into cards 102. Each flexographic print module has a flexographic unit and a drier. The printing of an individual layer is accurate to +/−30 micrometers. Print layer on print layer accuracy is +/−50 micrometers. The throughput through the flexographic printing station 400 is generally about 300 meters/min.

In alternative embodiments, there is a surface coating flexographic printing module before the first flexographic printing module 410. The surface coating module applies a surface coating of resin and surfactant which seals the surface so that the roll 101 is less porous and less likely to absorb inks. The surface coating gives the roll 101 a substantially uniform surface energy throughout, and a substantially uniform porosity.

In some embodiments there may be multiple layers of electrode applied so as to increase conductivity. The extra layers are applied on top of the original layer(s). This may be performed at the same flexographic printing module 410, or additional electrode layers may be applied at subsequent printing modules. The electrode inks are composed of resin, surfactant, carbon and graphite.

In an alternative embodiment, the surface deformation module 420 may be the final module after all flexographic inks have been applied. This can help improve the accuracy of the ink application processes.

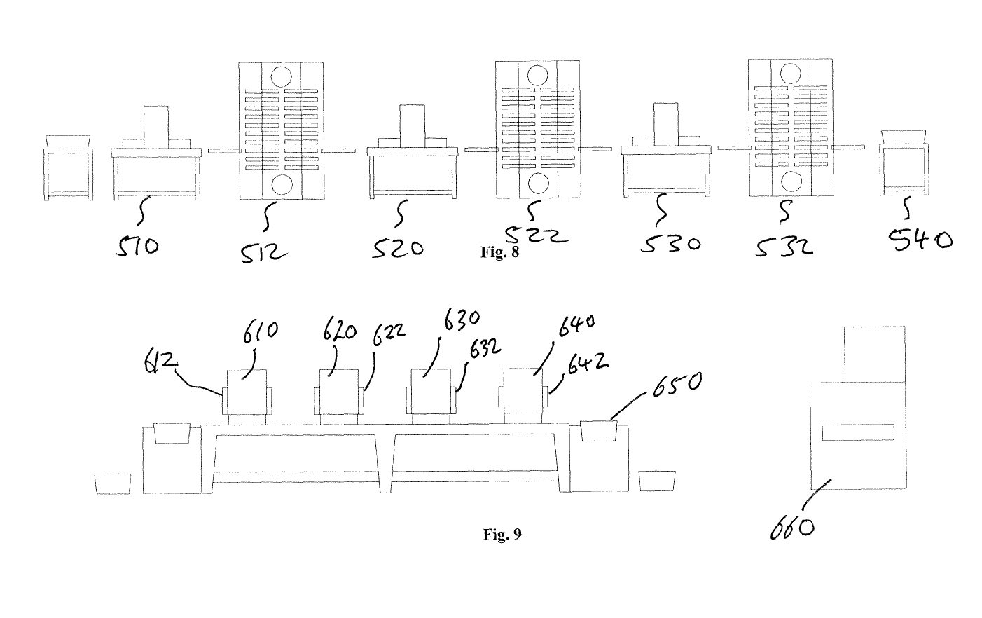

FIG. 8 is an expanded flow diagram of Step 2 of FIG. 6, and shows the precision dosing process at the precision dosing station 500 in more detail. Here inks are nano-dosed (120 nL+/−5 nL per ink) with volumetric and positional precision, with each well 122 creating an excellent three-dimensional target for each ink. Chemical solutions of the inks are produced, in this example, with ethanol as solvent. A card 102 from Step 1 is first introduced to a first dosing unit 510, where an ink solution containing a mixture of a mediator ink and an active ink is dosed into one well 122 per strip 100 on the card 102. It should be noted that embodiments which use the same ink in more than one well per strip may have each such well dosed with the same ink at the same dosing unit. The card 102 is then dried in a first drying unit 512 The card 102 proceeds to a second dosing unit 520 where another ink solution of mediator/active ink is dosed to another well 122 per strip 100 on the card 102. The card is then again dried in a second drying unit 522. Finally the card 102 proceeds to a third dosing unit 530 where yet another ink solution of mediator/active ink is dosed to a further well 122 per strip 100 on the card 102. The card is then dried in a third drying unit 532 and deposited in a second card collector 540. Optionally a fourth ink solution may be dosed into a further well, which ink solution contains a mediator/passive ink. In this embodiment the active ink contains glucose dehydrogenase. However, in other embodiments the active ink may be different to allow measurements relating to a condition other than diabetes. Alternatively the active inks present may be different from each other to allow simultaneous measurements relating to a plurality of conditions. It is during the precision dosing that different inks may be dosed depending on the measurements ultimately desired. For instance, dosing one ink for measuring glucose levels, and another for measuring ketone levels is easily achievable.

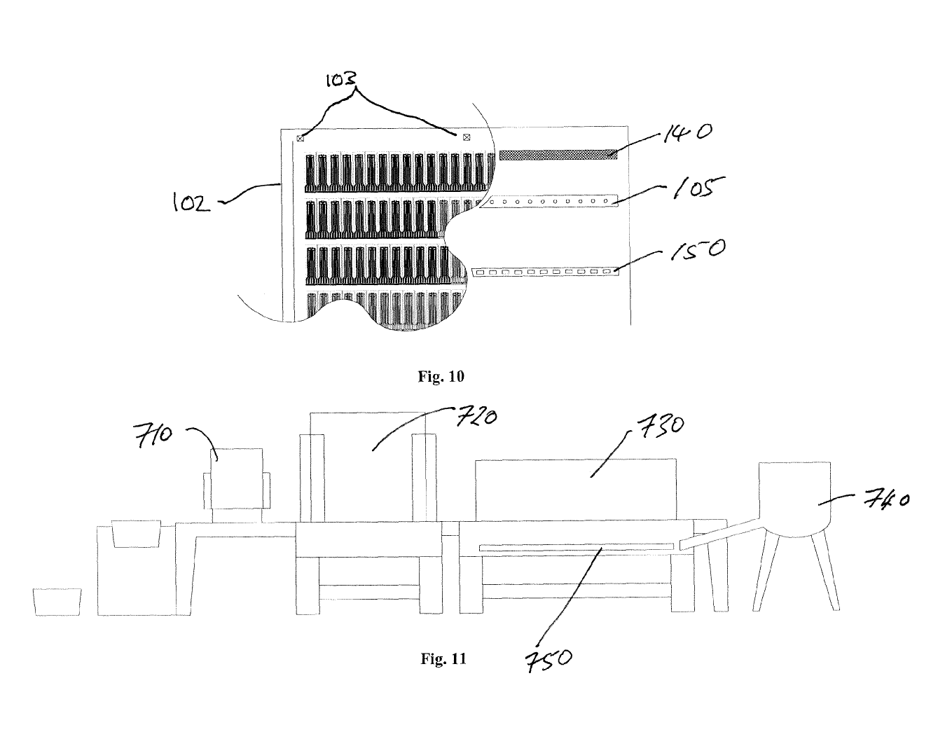

FIG. 9 is an expanded flow diagram of Step 3 of FIG. 6, and shows the card finishing process at the card finishing station 600 in more detail. FIG. 10 is a top view of a card produced at the card finishing station 600. The card finishing station 600 applies three further materials to the card 102: a mesh 140, a covering tape 105, and RFID tags 150 (radio-frequency identification strips). FIG. 10 also shows the registration points 103 spaced at regular intervals on the card 102. In Step 3 a card 102 from Step 2 is transferred to a machine bed of the card finishing station 600. In an embodiment which incorporates the mesh the card 102 is conveyed to a mesh-laying unit 610 with a card vision and position system 612. The vision system 612 establishes the precise location of the card 102. The card position system corrects the position of the card relative to the mesh-laying unit 610. The unit 610 places cross-hatched mesh ribbons 140 across the strips 100. A single mesh ribbon 140 is laid along a single row of strips 100. The mesh ribbons are anchored by ultrasonic welding before they are cut from feed rolls of the mesh ribbon 140. In another embodiment, this mesh-laying step is omitted. In yet another embodiment, the mesh-laying step is replaced by a step incorporating another structure or component which achieves the same effect as the mesh. The card 102 is then taken along the machine bed to a hotmelt pattern laying unit 620, where another vision system 622 pinpoints the location of the card before a hotmelt application head moves across the card 102. The card is then conveyed to a covering tape-laying unit 630. Lanes of covering tape 105 are positioned above the mesh ribbons 140. Another vision system 632 controls roll out of the covering tape 105 so as to correctly align a hole in the tape 105 with the loading port 110 and sample zone 120 of each strip 100. Downward pressure and heat is then applied to secure the covering tapes 105 before they are cut from their respective feed rolls. The card is then conveyed to an RFID ribbon-laying unit 640, where a vision system 642 again controls the positioning of the RFID ribbon 150 and again corrects the card position with a position system before downward pressure is applied to secure the RFID ribbon 150. The RFID ribbon 150 is self-adhesive and is placed near to the terminal contacts 136 at an end of the strip 100 which is connectable to the measurement device 200. Once the RFID ribbons 150 are cut from their feed rolls to leave RFID tags 150 on each strip 100, the card 102 then proceeds to a third card collector 650. At this stage the performance band of the batch of test strips is determined by destructively testing 1% of all finished cards 102 in a testing unit 660. The testing unit applies a precisely dosed glucose solution to each well 122 of a strip 100 taken from a card 102, and takes measurements to obtain a card's 102 performance profile data. This data is uploaded to a production control database and stored as part of a batch record. The data is then recalled in Step (see below). The mesh ribbons 140 are positioned with an accuracy of +/−200 micrometers or better, relative to the registration points on the card 102. The hotmelt pattern is positioned with an accuracy of +/−200 micrometers. The covering tape is positioned with an accuracy of +/−100 micrometers, as is the positioning of the hole in the tape relative to the loading port 110. The RFID ribbons are positioned with an accuracy of +/−200 micrometers.

FIG. 11 is an expanded flow diagram of Step 4 of FIG. 6, and shows the strip cutting and vialing process at the strip cutting and vialing station 700 in more detail. A finished card 102 is transferred from Step 3 to an input track of the station 700. The card is first taken to an RFID programming unit 710, where each of the RFID tags 150 associated with each strip is programmed by retrieving the performance profile data obtained in Step 3 from the batch record database. The data is imparted to the RFID tags 150 to be later read by the measurement device 200 when a patient inserts a strip 100 thereinto. The programmed card 102 is then taken to a row-cutting unit 720 where each card 102 is divided into 8 separate rows along the perforations. Such perforations help the accuracy of cutting, and therefore reduce the space needed between rows, thereby increasing the number of sampling plates per square meter. Wear and tear of the cutter is also reduced. Each card 102 has a waste area at either end. This waste area is removed as part of the row-cutting process and the waste is collected for disposal. The separated rows are collected and transferred to a strip cutting unit 730 where lasers (or alternatively knives) are used to convert each row into 25 individual strips 100. Each row has an area of waste material at each end, which is suitably removed and disposed of at the strip cutting unit 730. Closed vials are then introduced to the cutting and vialing station 700 via a vial hopper 740. Vials are transferred and orientated before being presented for filling. A filling system 750 opens each vial and places up to 25 strips therein before closing the vial. The vials of strips are stored until distribution requests are received. At this point the vials are retrieved and packaged with all necessary labelling, user guides, information, particularly information on performance bands. The strips are then ready for distribution. Row cutting is carried out with an accuracy of +/−100 micrometers. Strip cutting is carried out with an accuracy of +/−100 micrometres.

The original continuous roll 101 is made of paper-based material (i.e. card). In this example the card is coated with a lacquer. Alternatively, however, the roll 101 could be of polymer based materials, such as PVC or polycarbonate.

1. A sample measurement system for performing electrochemical measurements on a sample, the system comprising:
a sampling plate with a loading port for receiving a liquid substrate; and
a measurement device;
wherein the sampling plate comprises a sample zone with at least two discrete testing zones, which sample zone is arranged, in use, to separate the liquid substrate into at least two discrete samples, such that each sample occupies a respective testing zone; and the measurement device is operable to communicate with the sampling plate to measure one or more selected properties of any of the at least two samples.

2. The sample measurement system as claimed in claim 1, wherein the loading port is arranged on a top face of the sampling plate.

3. The sample measurement system as claimed in claim 1, wherein the sampling plate comprises a first flexographic print layer.

4. The sample measurement system as claimed in claim 1 wherein the sampling plate comprises an information tag.

5. The sample measurement system as claimed in claim 1, further comprising an adaptor to allow the measurement device to communicate with the sampling plate.

6. A sampling plate comprising:
a loading port for receiving a liquid substrate; and
a sample zone with at least two discrete testing zones, which sample zone is arranged, in use, to separate the liquid substrate into at least two discrete samples, such that each sample occupies a respective testing zone.

7. A measurement device for measuring a property of at least one liquid sample on a sampling plate, the measurement device comprising:
at least two electrodes adapted to bridge the at least one liquid sample within one of at least two discrete testing zones on the sampling plate,
whereby application of a potential difference between the at least two electrodes is capable of measuring the property of the at least one liquid sample.

8-15. (canceled)
